(19) United States
(12) Patent Application Publication
(10) Pub. No.: US 2007/0156503 A1
(43) Pub. Date: Jul. 5, 2007

(54) Merger integration framework and tool

(75) Inventors: Dorree Ebner, Haddon Heights, NJ (US); Arthur Bert, South Natick, MA (US); Kristin L. Ficery, Atlanta, GA (US); Bruce P. Kiene, Mesa, AZ (US); Jill S. Dailey, Chatham, NJ (US); Esther Yuste, New York City, NY (US); Ravi Chanmugam, New York, NY (US); Greg Chestnut, Boothwyn, PA (US); Thomas B. Gaultney, Woodstock, GA (US); Bill Pursche, Marshall, VA (US); Joanna J. Huang, Short Hills, NJ (US); Alex P. Dickey, Charlotte, NC (US)

Correspondence Address: OPPENHEIMER WOLFF & DONNELLY, LLP, PLAZA VII, SUITE 3300, 45 SOUTH SEVENTH STREET, MINNEAPOLIS, MN, 55402-1609, US

(73) Assignee: Accenture Global Services, GmbH, Schaffhausen (CH)

(21) Appl. No.: 11/606,438

(22) Filed: Nov. 30, 2006

Related U.S. Application Data
(60) Provisional application No. 60/741,008, filed on Nov. 30, 2005.
(60) Provisional application No. 60/740,703, filed on Nov. 30, 2005.

(51) Int. Cl. G06Q 99/00; G06F 15/02; G06F 9/46

(52) U.S. Cl. 705/9; 705/1

(57) ABSTRACT

A method and computer system are provided for navigating an electronic methodology tool for a merger integration of businesses. The methodology tool is configured to display to a user various activities for accomplishing an integration of businesses. Each of the activities has associated tasks for completing the activity. A first indicia is received from the user that signifies a desired merger integration role, merger integration phase, or merger integration industry. Responsive to receipt of the first indicia, a subset of the activities is displayed to the user. The subset of the activities is selected from the activities based on the first indicia received from the user. A second indicia is received from the user that signifies a desired activity, which is selected by the user from among the displayed subset of activities. Responsive to receipt of the second indicia, various tasks for completing the desired activity are displayed to the user.

### CROSS REFERENCE TO RELATED APPLICATIONS

This application claims the benefit of U.S. Provisional Application Nos. 60/741,008, filed Nov. 30, 2005 and 60/740,703, filed Nov. 30, 2005, the contents of which are incorporated herein in their entirety.

### BACKGROUND OF THE INVENTION

In our modem market economies, many companies have tried to maintain or enhance profitability by focusing upon finding synergies that can be obtained by acquiring or merging with or by alliances with other companies. These synergies, for example, could result from cost reduction provided by eliminating duplication of resources, economies of scale or vertical and horizontal integration. Business mergers are therefore becoming increasingly more frequent occurrences in many markets and industries. Such mergers are becoming more and more complex with the involved companies being large and diverse, and often much of their fiscal health and growth upon the success of the merger. Success of the merger is thus of paramount importance.

Many businesses turn to external consulting firms or other specialists to evaluate proposed mergers, to assist in planning activities in an upcoming scheduled merger, and to manage the transition period for an ongoing merger. Much must happen in a relatively short time period for a merger to proceed successfully, including the merging of organizations, cultures, and technologies, and the elimination of redundant resources. The best elements from each of the original companies must be maintained, even as new elements needed by the resulting merged company are established. An experienced consulting firm or other organization of specialists advantageously brings to bear its pooled expertise and best practice knowledge with regard to these merger-related (or acquisition-related) changes. While one or more of the managers of the merging companies may have experience regarding a few prior mergers, the more experienced specialists may have the benefit of working on more total mergers than the combined experiences of all the managers of the merging companies. Thus, specialist firms are able to capitalize upon their wider scope of past experience and specific knowledge regarding the lifecycle of mergers, utilizing knowledge of commonly encountered problems and pitfalls, guideposts for tracking progress, and ways to solve problems and avoid pitfalls to more efficiently direct the merging companies to meet the ultimate business objectives underlying the merger.

While specialists can be hired at the pre-merger stage (i.e., during negotiations or prior to a deal being announced publicly), oftentimes, specialists are hired into a post-merger situation to manage a merger after the companies have already signed contracts and announced the merger, and sometimes even after various post-merger integration steps have been taken. When a particular specialist or specialist organization is brought into a merger situation after the pre-merger stage, they must be able to get a quick, yet accurate snapshot assessment regarding where the merging company stands in the various tasks that should be completed by the merger integration process. Only after getting an accurate snapshot can the specialists utilize their personal experiences and expertise to advise the client companies how to improve their post-merger integration efforts. Thus, in order to make the business relationship between the specialist and the merging companies successful, the specialist organizations must have the capability to assess and guide the progress of the merger efficiently and accurately at various times within the merger lifecycle.

The management of post-merger integration can be heavily dependent upon the personal knowledge of the involved specialists. While a particular “lead” specialist within a specialist organization may be very knowledgeable regarding particular areas of post-merger integration, that particular specialist will likely not be able to perform a complete and accurate assessment in a quick manner on their own. These lead specialists typically enlist additional personnel resources from their organization, usually in the form of a team of less experienced specialists that will work under the direction of the lead specialist. These team members are often given the tasks of information gathering and sorting, such as by contacting and interviewing employees of the merging companies and obtaining, reviewing and organizing records relevant to post-merger integration activities. These can be complicated as progress assessments are often necessary at various times during a merger integration. Notably, merger integrations generally evolve according to a life cycle of different phases, characterized by different goals, tasks and activities. Thus, certain types of information may only be relevant to (or more relevant to) making progress assessments during one phase of a post-merger integration while less relevant or irrelevant to making progress assessments undertaken at other stages or phases of the integration. The team members therefore need direction regarding what information to seek at a particular time and from what sources to seek that information.

Since a specialist organization's worth to merging companies lies in the collective experiences and knowledge capital of its various individual specialists, it is important for those organizations to leverage this past experience and knowledge effectively by disseminating it to other specialists within the same organization. Only then can this knowledge and experience be utilized fully in the progress assessments of various mergers by many specialists within the organization in a manner that enables teams to perform the planning and analysis as quick, economical, consistent, and accurate as is possible. Thus, in order to make the business relationship between the specialist and the merging companies successful, there also is a need for the specialist organization to have mechanisms for effectively sharing the knowledge and experience of lead specialists with their team members. Such sharing allows the specialist organization to be certain to obtain the most relevant information needed to identify those important post-merger activities and tasks to be addressed.

Therefore, there is a need for improved mechanisms for obtaining methods, best practices, and tools associated with a successful integration of two or more companies where those mechanisms overcome the inherent difficulties in performing detailed planning and analysis. A mechanism that directs members of the specialist team to acquire the necessary information from the proper sources at the appropriate times during a merger or acquisition integration (henceforth, collectively referred to as “merger integration”) would greatly simplify the task of completing the activities needed during post-merger integration and enable teams to conduct activities in a more efficient manner. Further, mechanisms for organizing and sorting the collected best practices and methods would greatly simplify the teams in conducting such tasks in the future. Likewise, a mechanism that identifies problem areas in the integration and associates those problems with suitable remedial or corrective actions to be taken to improve the situation of the merger in those areas would be beneficial.

### BRIEF SUMMARY OF THE INVENTION

In accordance with one embodiment of the present invention, a method in a computer system is provided for executing a merger integration of businesses after a merger or acquisition between the businesses. A merger framework is established for providing direction to integrating the businesses, including generating a merger integration roadmap. Integration plans are developed in accordance with the merger framework. The integration plans define a prioritized set of integration activities and are directed to strategic objectives and tactical objectives. The integration plans for integrating the businesses are executed, and the computer system directs the integration of businesses in accordance with the merger framework via a user interface. The user interface enables users to select requested information and search for the information via a number of methods. Results are displayed to the user that corresponds to the merger framework based on the selection of the user.

In another aspect of the present invention, a method in a computer system is provided for navigating an electronic methodology tool for a merger integration of businesses after a merger or acquisition between the businesses. The methodology tool is configured to display to a user various activities for accomplishing the integration of businesses. Each of the activities has associated tasks for completing the activity. A first indicia is received from the user that signifies a desired merger integration role, merger integration phase, or merger integration industry. Responsive to receipt of the first indicia, a subset of the activities is displayed to the user. The subset of the activities is selected from the activities based on the first indicia received from the user. A second indicia is received from the user that signifies a desired activity, which is selected by the user from among the displayed subset of activities. Responsive to receipt of the second indicia, various tasks for completing the desired activity are displayed to the user.

In the foregoing methods, integration plans and the activities may be categorized and displayed to a user by a desired merger integration phase, such as an establish merger framework phase, a conduct integration planning phase, or a execute integration plans phase. Similarly, integration plans and the activities may be categorized and displayed to a user by a desired merger integration role, such as a program management role, a value creation role, or a merger enablement role. The subset of the activities may be customized based upon a merger integration role or the merger integration industry. Moreover, the tasks for completing the desired activity may be customized based upon the desired merger integration role or the desired merger integration industry. The desired integration industry may include any industry, such as the banking industry or the retail brokerage industry. The desired integration role may include any merger integration role, such as program management, value creation, or merger enablement roles.

### BRIEF DESCRIPTION OF THE DRAWINGS

FIG. 1 is a diagram of an exemplary timeline flowchart of the Merger Integration Playbook framework in accordance with one embodiment of the present invention;

FIG. 2a is a diagram of an exemplary flowchart and relative timing configuration of activities for the Establish Merger Framework phase of the Merger Integration Playbook framework of FIG. 1 in accordance with one specific implementation;

FIG. 2b is a diagram of an exemplary flowchart and relative timing configuration of activities for the Conduct Integration Planning phase of the Merger Integration Playbook framework of FIG. 1 in accordance with one specific implementation;

FIG. 2c is a diagram of an exemplary flowchart and relative timing configuration of activities for the Execute Integration Plans phase of the Merger Integration Playbook framework of FIG. 1 in accordance with one specific implementation;

FIG. 3 is a diagram of an exemplary key task screen for the Mobilize and Launch Program Management activity, in accordance with one specific implementation;

FIG. 4 is a diagram of an exemplary integration of a Financial Services M&A Planning Guide and a Corporate Strategy PMI Playbook in accordance with one embodiment of the present invention;

FIG. 5 is a diagram of an exemplary structure of the Merger Integration Playbook framework of FIG. 1, incorporating aspects of a M&A Planning Guide and a Corporate Strategy PMI Playbook in accordance with one embodiment of the present invention;

FIG. 6 is a diagram of an exemplary user interface navigation home screen of the Merger Integration Playbook tool in accordance with one specific implementation;

FIG. 7a is a diagram of an exemplary user interface role/responsibility screen of the Merger Integration Playbook tool in accordance with one specific implementation;

FIG. 7b is a diagram of an exemplary user interface activity/task screen of the Merger Integration Playbook tool in accordance with one specific implementation;

FIG. 8a is a diagram of an exemplary user interface banking home page of the Merger Integration Playbook tool in accordance with one specific implementation;

FIG. 8b is a diagram of an exemplary user interface ATM topic screen of the Merger Integration Playbook tool in accordance with one specific implementation;

FIG. 8c is a diagram of an exemplary user interface ATM activity/task screen of the Merger Integration Playbook tool in accordance with one specific implementation;

FIG. 9a is a diagram of an exemplary directory structure for supporting a banking industry merger integration in accordance with one specific implementation;

FIG. 9b is a diagram of an exemplary banking industry framework of the Merger Integration Playbook tool in accordance with one specific implementation;

FIG. 10 is a diagram of an exemplary activity tracker screen for a banking industry merger in accordance with one specific implementation;

FIG. 11 is a diagram of an exemplary activity tracker screen for a retail brokerage industry merger in accordance with one specific implementation;

FIG. 12 is a diagram of an exemplary activity tracker screen for core functionality topics in accordance with one specific implementation;

FIG. 13 is a diagram of an exemplary activity tracker screen for the roles/responsibilities for a merger in accordance with one specific implementation; and

FIG. 14 is a diagram of an exemplary activity tracker screen for phases of a merger in accordance with one specific implementation.

### DETAILED DESCRIPTION OF THE INVENTION

A. Merger Integration Playbook Overview

Embodiments of the present invention as described herein enable managers of a merger integration to guide, collect, organize, review and analyze information and data relevant to a merger integration execution in a facilitated manner. The various embodiments of the present invention provide methods and related tools and electronic resources that utilize a Merger Integration Playbook to guide managers through the different phases of a merger integration life cycle, enabling the performance of the integration successfully and rapidly during each phase.

As used herein, “Merger Integration Playbook” refers to both a framework methodology and an electronic tool that facilitates implementation of the framework methodology. The Merger Integration Playbook framework methodology includes a collection of merger best practices that have been aggregated to provide a structured yet flexible system for managing and executing merger integrations, wherein the framework is both strategic and tactical. The Merger Integration Playbook tool integrates the general phases, activities, and tasks identified by the framework that need to be performed to complete a merger integration. The tool associates activities and tasks with their corresponding key roles, as described herein, and provides a flexible electronic navigation tool that guides and tracks the progress of a merger integration team. Further, in certain embodiments of the present invention, the tool may be tuned for key industry teams, such as those teams in the banking and retail brokerage industries.

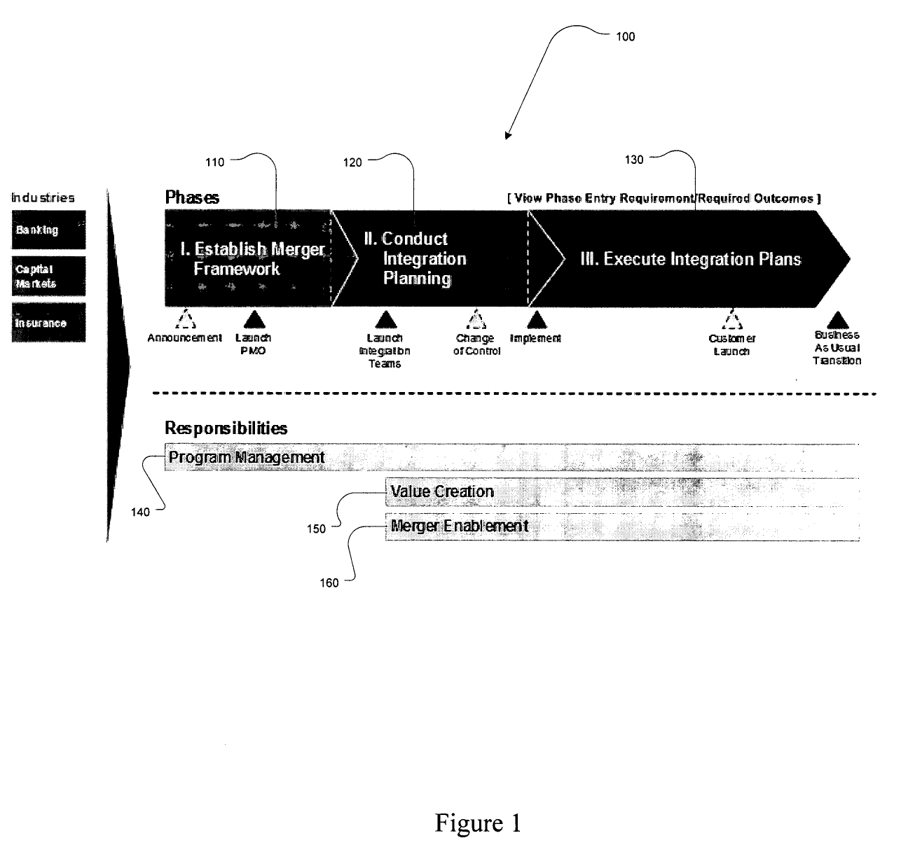

With reference to FIG. 1, the Merger Integration Playbook may categorize merger integrations in three general phases: establishing the merger framework 110, conducting integration planning 120, and executing the integration plans 130. The Merger Integration Playbook tool, described in more detail herein, contains user tools that support, guide, and track a merger team through all three phases of the post-deal merger integration.

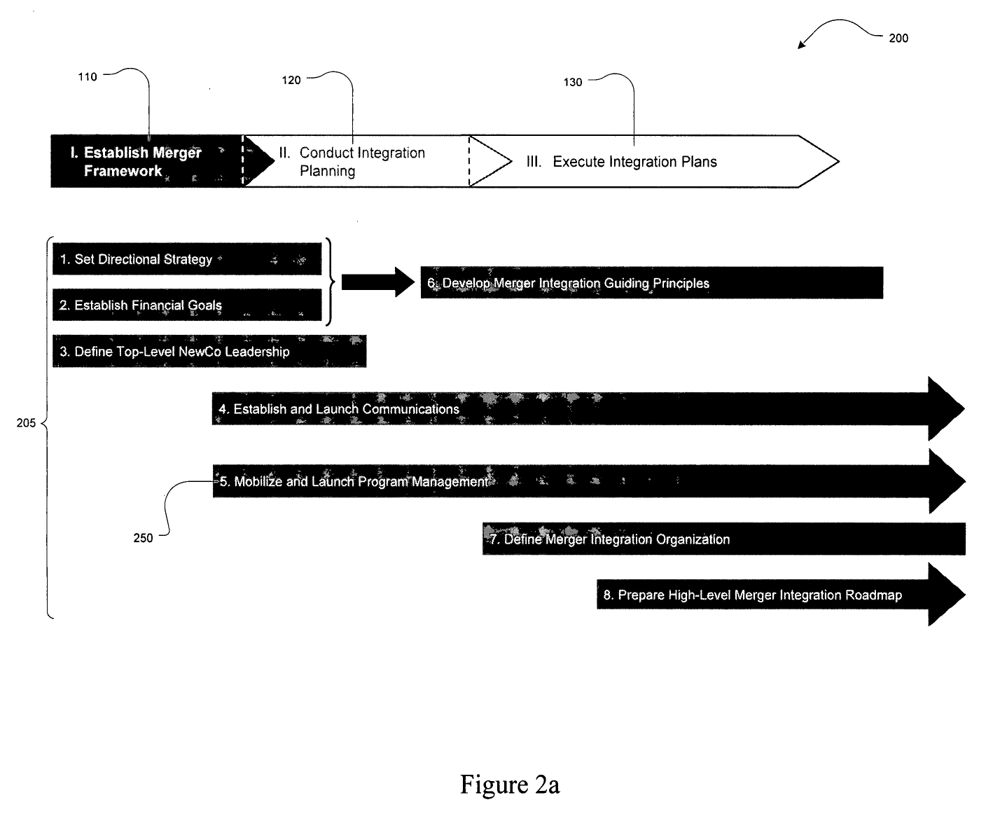

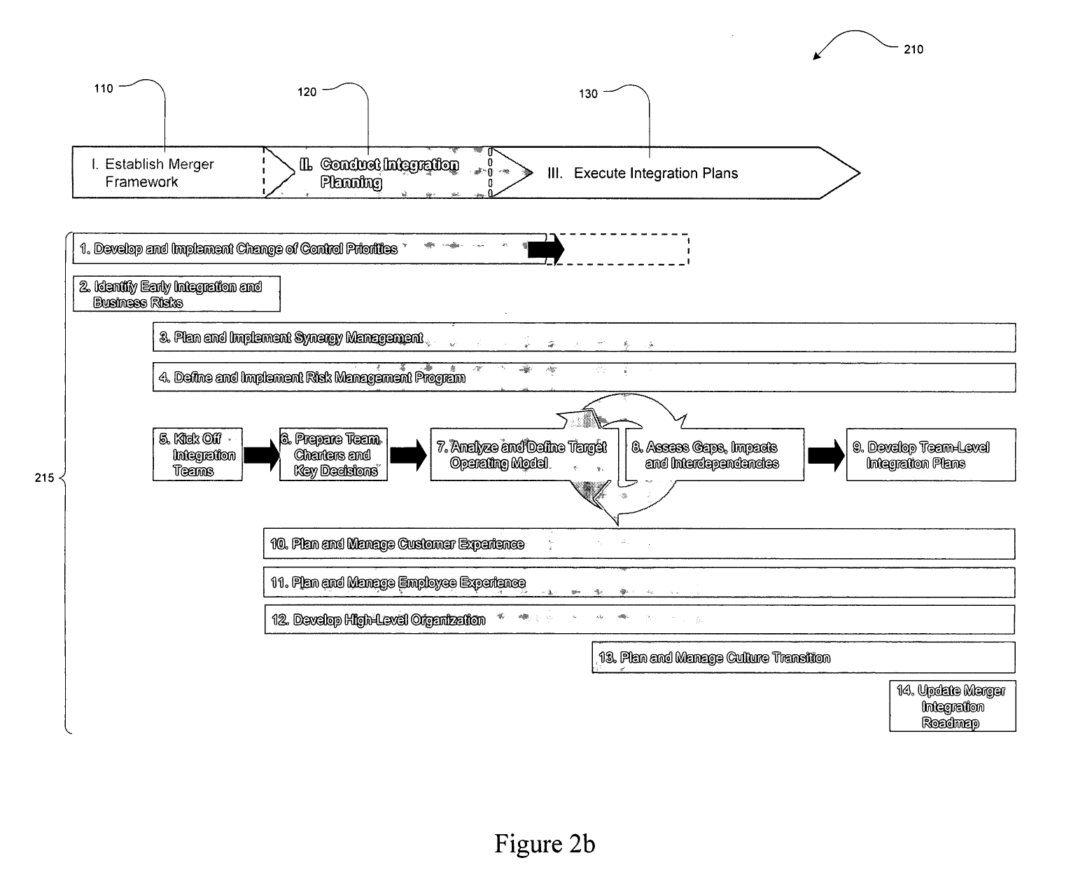

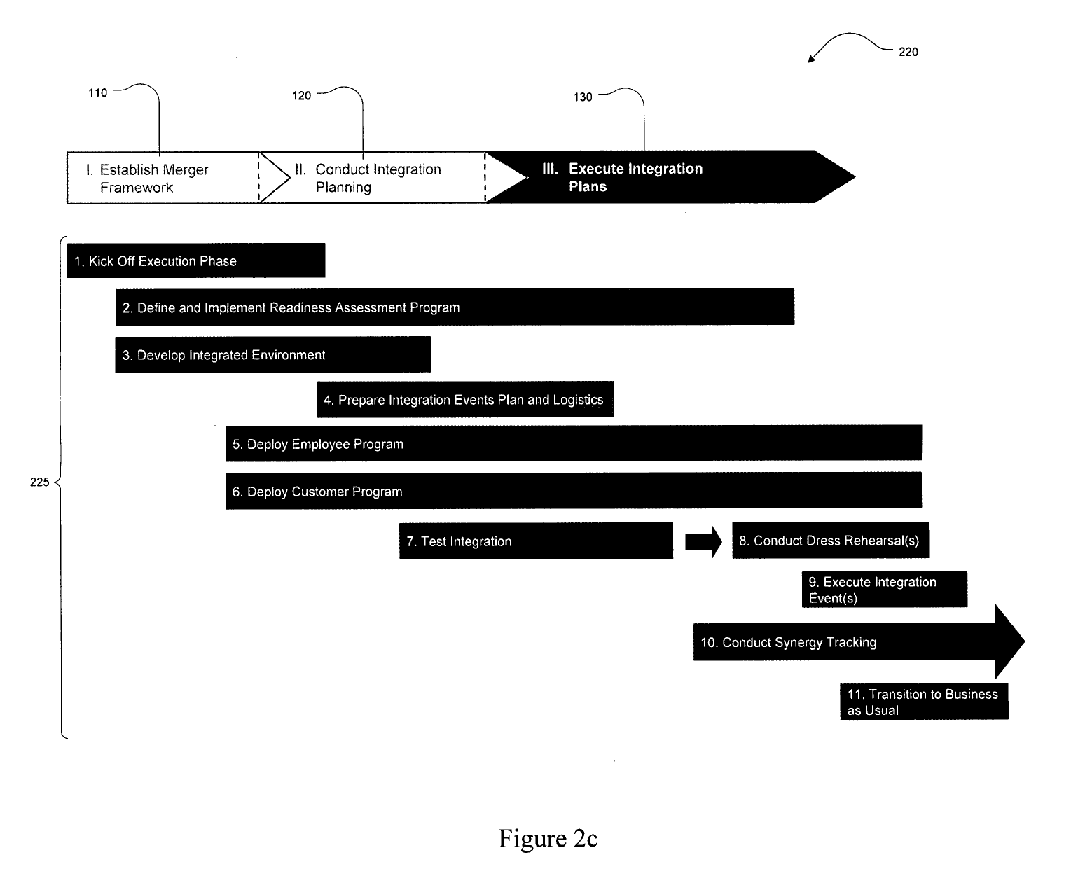

Each phase may include one or more activities, where each activity defines a stream of work. For example, the activities 205 associated with the “Establish Merger Framework” phase 110 in accordance with one embodiment of the present invention are shown on activity screen 200, as seen in FIG. 2a, and facilitate the generation of a merger integration roadmap. The activities 215 associated with the “Conduct Integration Planning” phase 120 in accordance with one embodiment of the present invention are shown on activity screen 210, as seen in FIG. 2b. The activities 225 associated with the “Execute Integration Plans” phase 130 in accordance with one embodiment of the present invention are shown on activity screen 220, as seen in FIG. 2c. FIGS. 2a-2c illustrate various activities 205, 215, 225 relating to the three phases 110, 120, 130 in a chronological manner and in some instances a chronologically overlapping manner. However, other chronologies for the activities are possible and in some cases the activities are not performed sequentially.

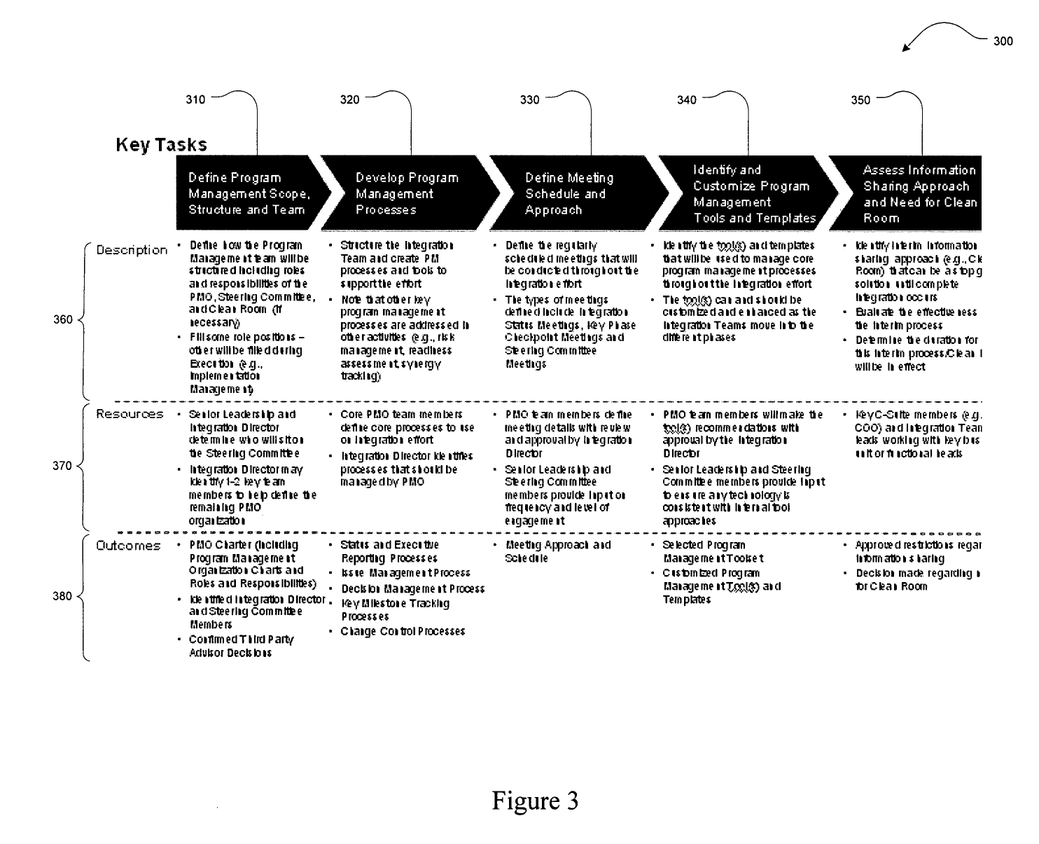

For each activity within a phase, documentation is recorded by a merger integration team member and maintained to track relevant aspects of the activity. For example, the documentation for an activity 205, 215, 225 may include one or more of the following: overview/objective, key outcomes, best practices, key considerations/challenges, and key tasks. The key tasks represent discrete components of work that comprise an activity. In one embodiment, the “Establish Merger Framework” phase 110 includes activity 250, “Mobilize and Launch Program Management,” as shown in FIG. 2a, where the key tasks for activity 250 include: “Define Program Management Scope, Structure and Team” 310, “Develop Program Management Processes (e.g., Issue Tracking, Status Reporting, etc.)” 320, “Define Meeting Schedule and Approach (e.g., Status Meetings, Checkpoints, Steering Committee, etc.)” 330, “Identify and Customize Program Management Tools and Templates” 340, and “Assess Information Sharing Approach and Need for Clean Room” 350. FIG. 3 shows a key task screen 300 that illustrates each of these key tasks for activity 250, along with their associated description 360, necessary resources 370, and expected outcomes 380.

Each of the activities 205, 215, 225 associated with each of the three merger integration phases 110, 120, 130 shown in FIGS. 2a-2c may include associated description, necessary resources, and expected outcomes to guide the merger process. Additionally, customized activities and tasks may be determined and created that align with a specific role or industry in support of merger integration activities.

Referring again to FIG. 1, merger integration managers and team members who are engaged with the merger may be categorized into resource groups such as program management 140, value creation 150, or merger enablement 160. Program management resource group members 140 provide the overall framework and governance to support the organization through all phases of integration. This includes senior leadership, steering committee, Program Management Office, (PMO), Synergy Management and where applicable Clean Room. Value Creation resource group members 150 are part of one or more integration teams are established to support the value creation responsibilities as determined based upon the value drivers of the deal to achieve synergies through cost reduction or revenue growth. Members of the Merger Enablement resource group 160 play a merger enabler role across the organization and participate on teams such as HR, IT, Facilities, Legal, Marketing, etc. Merger Enablement team members 160 may also be Value Creation team members.

The foregoing activities and tasks associated with each phase of a merger integration are exemplary. Individual tasks and even entire activities may be altered, customized, added, or removed based on the requirements of a specific merger. For example, the merger integration framework may be tailored to entities in the banking industry, the retail brokerage industry, or other industries. In one embodiment, the integration framework may be adapted to the banking industry whereby customized activities and tasks may be created to align to specific topics within the banking industry including: ATM's, Branches (Branch Consolidations, Branch Divestitures, Branch Integration, Branch Support), Call Center/VRU, Corporate and Investment Banking, Credit Cards, Deposit Operations (Account Numbering, Operational Site Consolidation, Deposit Operations Integration), Lending (Consumer, Commercial, Mortgage), Online Banking, Product Management, Relationship Management (Customer Alignment and Segmentation, Small Business Banking, Commercial Banking, Private Banking), Treasury Management Operations, and Wealth Management Services.

In an alternative embodiment, the merger integration framework may be adapted to the retail brokerage industry whereby customized activities and tasks may be created to align to specific topics within the retail brokerage industry including: Account Operations, Accounts, Annuities, Clearing/Settlement, Correspondent Clearing, Discount/Online, Full Service, In-Bank, Independent FA/Boutique, Investment Products, Money Market Operations, Money Movement, Mutual Fund Operations, Reference Data, Research, Securities Processing, Wealth Management, and Trade Desk.

In some embodiments, the integration framework may be adapted to either the banking or retail brokerage industries, or other industries, by customizing activities and tasks that align to selected Core Functions within the pertinent industry including: Corporate Administrative Services(Legal/Compliance, Audit, Risk Management, Tax, Corporate Communications, Business Continuity), Facilities/Real Estate, Marketing/Customer Experience (Customer Communications/Retention, Marketing Consolidation, Brand Development/Rollout, Customer Information Management), Finance/Control (General Ledger Consolidation, Financial Reporting, Synergy and Integration Cost Tracking, Bank Treasury), HR/Employee Experience (Benefits/Payroll Consolidation, Employee Communications, Employee Management), Information Technology (Infrastructure, Technology Support, Application Development and Management, Data Management and Migration, Disaster Recovery, Test Planning and Implementation), and Procurement/Sourcing (Contract/Vendor Management, Forms/Supply Ordering).

The Merger Integration Playbook tool is an electronic apparatus that provides a user interface and associated logic and data storage to guide and support a merger integration in accordance with the Merger Integration Playbook framework. The tool is integrated with a standard or customized version of the framework and provides a user with a graphical navigation functionality that aligns with the framework, as described in more detail herein. The tool's user interface may be provided through an online, web-based technology or in a standalone or other offline format.

B. Conducting Post-Deal Merger Integration Across Both Strategic and Tactical Areas

The Merger Integration framework, and in particular the post-deal phase framework, may be established to provide direction to the integrating businesses by developing integration plans for defining a prioritized set of integration projects. The integration plans may be directed to strategic objectives and tactical objectives. As used herein, the term “strategic objectives” refers to those objectives or areas of the merger integration relating to key objectives of a merger, implementation of the merger, and other upfront strategy-related aspects of a merger. As used herein, the term “tactical objectives” refers to those objectives or areas of the merger integration relating to technology integration planning, data conversion procedures, and other execution-level objectives. Thus, the strategic objectives focus on financial goals and value drivers for those goals, and the tactical objectives focus on execution activities that achieve the strategic objectives.

Specifically, the Merger Integration Playbook may provide for a method of conducting post-deal merger integration across both strategic and tactical areas as follows. The Merger Integration Playbook leverages components from both a financial services M&A planning guide and a corporate strategy Post-Merger Integration (PMI) Playbook. The PMI Playbook was developed from a strategic perspective that focuses on top-level financial goals and value drivers that enabled achievement of those goals. In contrast, the financial services M&A planning guide provides a merger lifecycle navigation tool that focuses on the delivery and execution activities necessary to achieve the strategic objectives previously set.

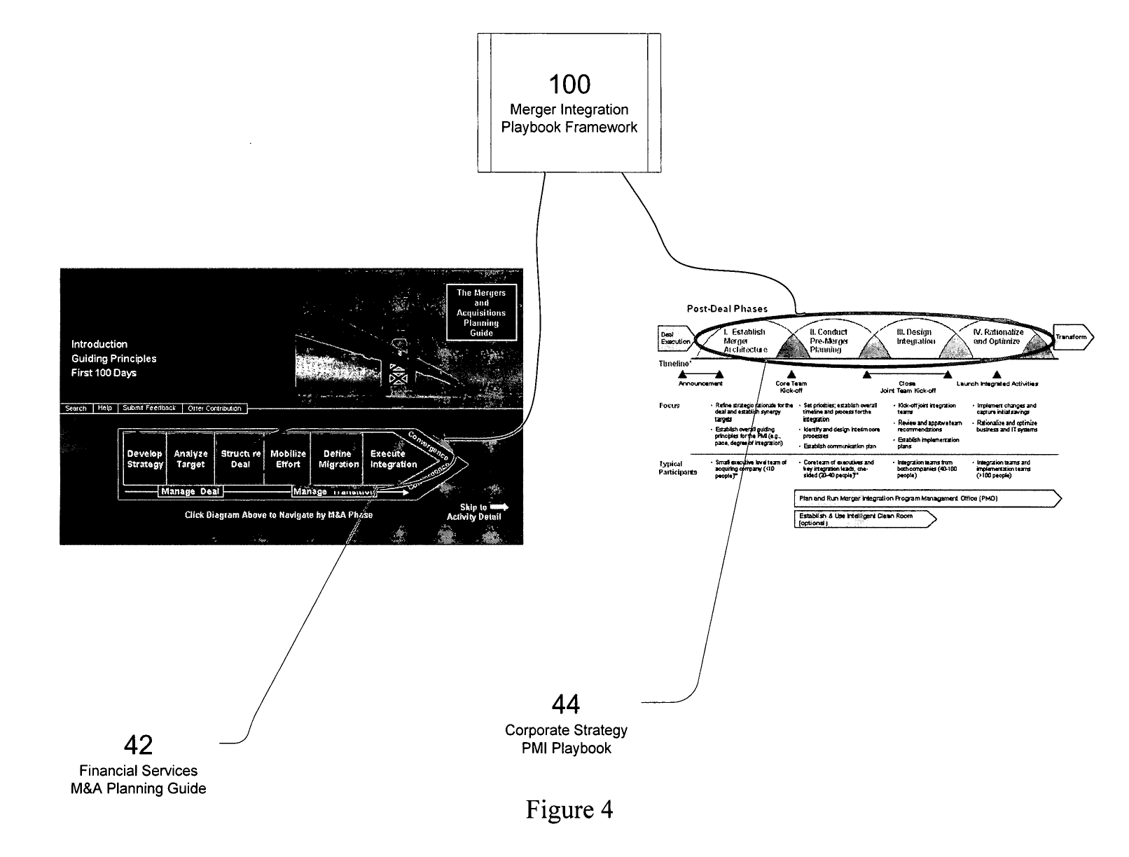

Accordingly, the Merger Integration Playbook combines practices and methods from the PMI Playbook with the practices and methods from the M&A planning guide and develops a comprehensive approach to merger integration that ensures that the strategic objectives are clearly understood and aligned to execution goals. For example, referring to FIG. 4, the Merger Integration Playbook Framework 100 may merge delivery and execution transition activities 42 from an M&A planning guide, including “Mobilize Effort,” “Define Migration,” and “Execute Integration,” with post-deal phase goals 44 from a PMI Playbook, including “Establish Merger Architecture,” “Conduct Pre-Merger Planning,” “Design Integration,” and “Rationalize and Optimize.”

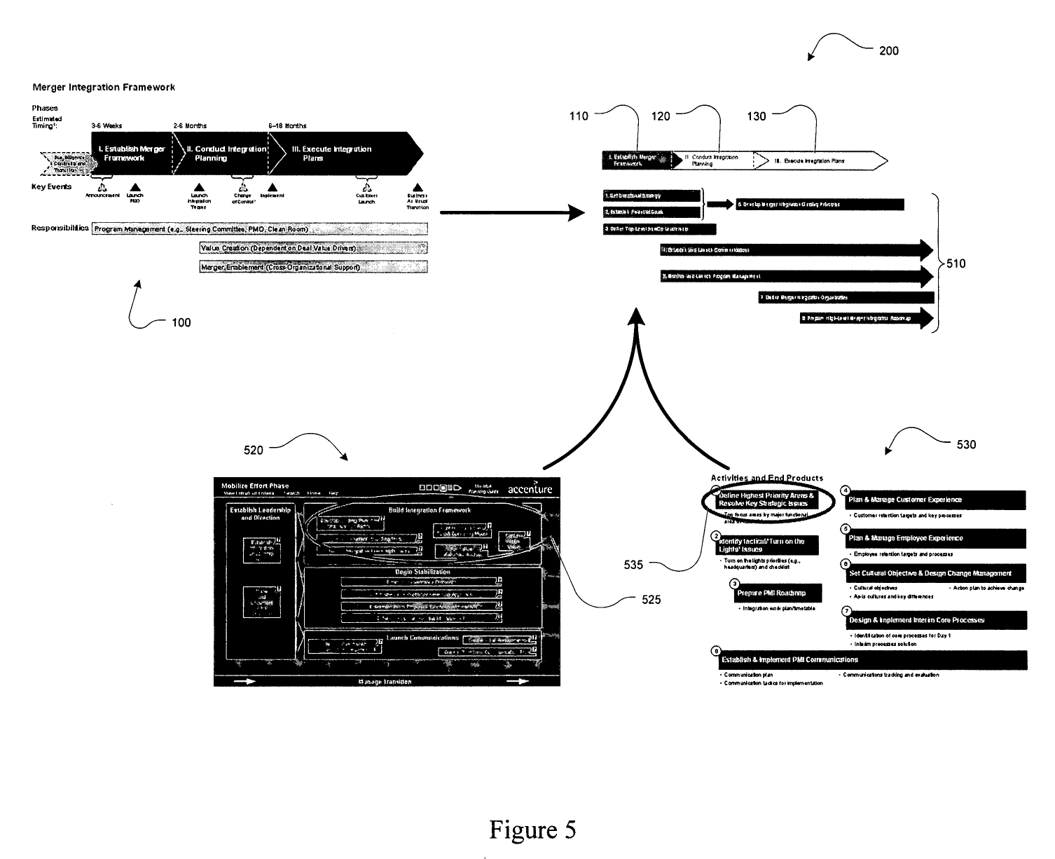

Referring to FIG. 5, the Merger Integration Playbook Framework 100 may be structured with activities and tasks, as shown in the “Establish Merger Framework” activities 510, by incorporating a “Mobilize Effort Phase” 520 of the M&A planning guide and the “Activities and End Products” 530 of the PMI Playbook. Specifically, the activity and associated tasks of the “Build Integration Framework” 525 within the “Mobilize Effort Phase” 520 are strategically combined with the “Define Highest Priority Areas & Resolve Key Strategic Issues” activity 535 to develop the activities and tasks of the “Establish Merger Framework” 510 by identifying key activities and tasks from each of the methods 520 and 530. The resultant methodology thereby contains increasingly strategic tactics relating to synergies and value creation while simultaneously ensuring focus on the feasibility of planning and execution of the merger integration.

C. Flexible Navigation of the Merger Integration Framework Methodology

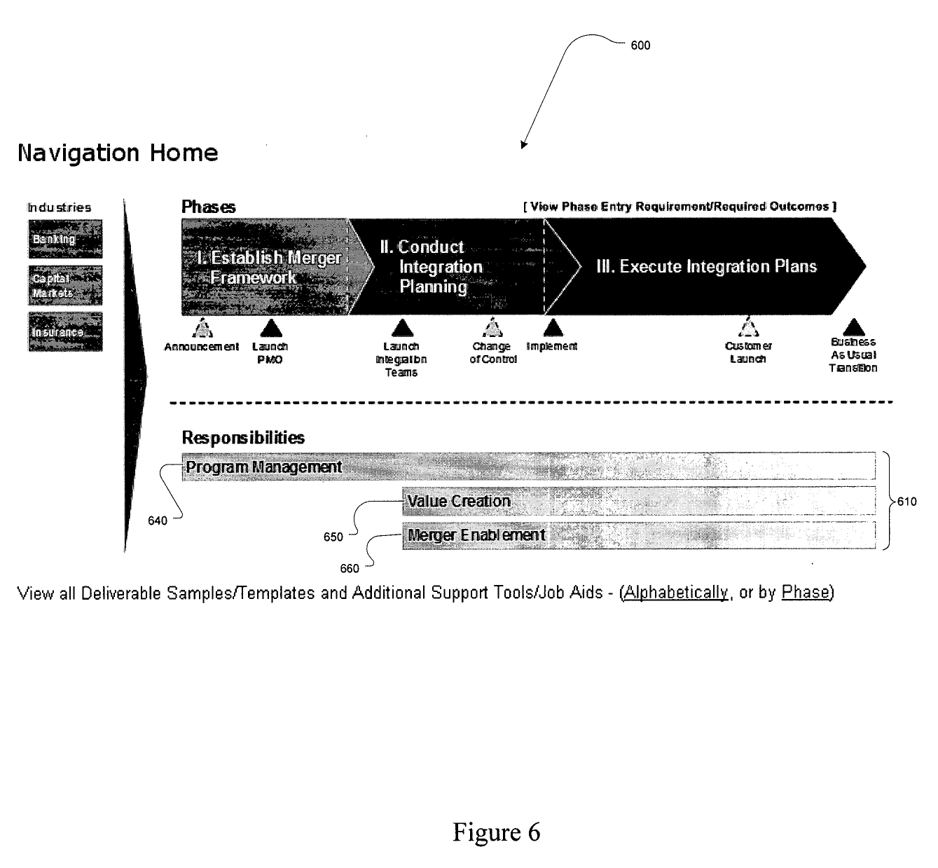

The Merger Integration Playbook tool provides for user navigation by phase, role/responsibility, and industry. User navigation may be conducted by other categories as appropriate, and the information that is displayed to a user during navigation may be customized based on the user or details of a specific merger integration. Referring to FIG. 6, the Merger Integration Playbook tool provides for a method and user interface for navigating the Merger Integration Playbook methodology that is displayed by role or responsibility. The information displayed on the navigation home screen 600 of the Merger Integration Playbook tool incorporates the phase and responsibility structures seen in the framework 100 shown in FIG. 1. Role buttons 610 correspond to the identified key roles or responsibilities that support a merger integration program in the Merger Integration Playbook tool for this embodiment, such that the buttons 610 include a program management button 640, a value creation 650 button, and a merger enablement 660 button.

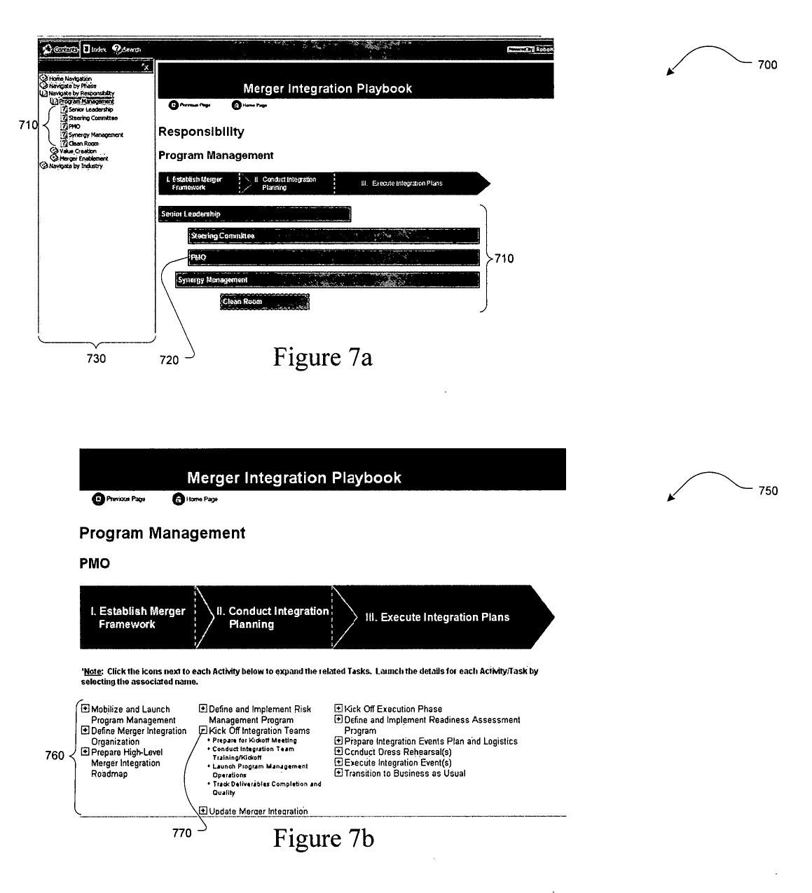

The Merger Integration Playbook tool provides for user navigation to drill down into the activities and tasks that are relevant to each of the defined responsibilities and roles/sub-roles. For example, a user may select any of the roles buttons 610 shown in the navigation home screen 600 user interface, shown in FIG. 6. Responsive to such selection, the tool displays the corresponding activities or tasks associated with the selected role. For example, when a user selects the program management button 640 on the navigation home 600, the various sub-roles 710 of “Program Management” may be displayed on the “Program Management” role/responsibility screen 700 to the user as seen in FIG. 7a. The “Program Management” Role/Responsibility screen 700 may display the “Program Management” sub-roles 710 in either a diagrammatical form or in a directory tree 730, which is displayed as a navigation pane in FIG. 7a. Users can navigate by interacting with the diagram or the table of contents.

Upon user selection of any one of the sub-roles 710, the corresponding activities or tasks may be displayed. For example, when a user selects the sub-role Program Management Office (PMO) 720 on the Role/Responsibility screen 700, the Merger Integration Playbook tool responds by displaying a screen 750 that identifies the activities and tasks 760 that are designated for completion by the PMO, as seen in FIG. 7b. The displayed activities and tasks may include the activities and tasks identified in FIGS. 2a-2c. As seen in FIG. 7b, the activities 760 displayed on screen 750 correspond to the activities identified in FIGS. 2a-2c that correspond to the PMO responsibilities. Thus, rather than displaying activities by temporal relationship or by phase, as in FIGS. 2a-2c, the screen 750 in FIG. 2b allows users to navigate by role. Some of the PMO activities and tasks 760 displayed on screen 750 may also be required for other roles or sub-roles.

Additionally, some or all of the activities and tasks 760 displayed on screen 750 may include customized or modified versions of the previously identified activities and tasks that are tailored to the PMO sub-role. “Kick Off Integration Teams” 770, for example, includes tasks that are specific to the PMO and may not be applicable to other roles or sub-roles. Where appropriate, custom activities and tasks may be defined to provide additional value based on the details of the specific merger integration being facilitated.

As previously described, the Merger Integration Playbook tool also provides for user navigation by phase and industry, in addition to navigation by role/responsibility. User navigation may be provided by phase, thereby allowing a user to view activities and tasks by the phase with which they are associated. For example, responsive to a user selection that signifies the “Establish Merger Framework” phase 110, the Merger Integration Playbook tool may display a user interface screen 200 that displays activities 205 associated with the “Establish Merger Framework” phase, shown in FIG. 2a. Responsive to a user selection that signifies the “Conduct Integration Planning”phase 120, the Merger Integration Playbook tool may display a user interface screen 210 that displays activities 215 associated with the “Conduct Integration Planning” phase, shown in FIG. 2b. Responsive to a user selection that signifies the “Execute Integration Plans” phase 130, the Merger Integration Playbook tool may display a user interface screen 220 that displays activities 225 associated with the “Execute Integration Plans” phase, shown in FIG. 2c.

Additionally, when navigating by phase, a user may drill-down into any desired activity to view the tasks and other related information that correspond to the desired activity. For example, a user view the “Establish Merger Framework” phase screen 2a on the Merger Integration Playbook tool may select an activity, such as activity 250, “Mobilize and Launch Program Management.”Responsive to such selection, the Merger Integration Playbook tool displays to the user the key task screen 300, which includes various corresponding key tasks 310, 320, 330, 340, 350 and along with their associated description 360, necessary resources 370, and expected outcomes 380, shown in FIG. 3. The Merger Integration Playbook tool provides for comparable navigation by industry as described below.

D. Customized Methodology by Industry

Activities and tasks defined in the Merger Integration Playbook tool may be determined and customized so as to be relevant to the specific industry of the merger. For example, the Merger Integration Playbook tool allows users to navigate the methodology after it is customized by integration team for the banking industry, the retail brokerage industry, or other industries. Where appropriate, custom activities and tasks may be defined to more fully address the needs of a merger occurring in an industry such as banking or retail brokerages.

Such customization may be accomplished by merging predefined best practices for such industries into an existing Merger Integration Playbook framework so that the best practices are integrated into the tool and user interface, thereby providing a frame of reference to the user that is tailored to a particular industry. In one embodiment, activities and tasks that have been identified as being within the best practices for an industry may be applied to the overarching Merger Integration Playbook framework as appropriate.

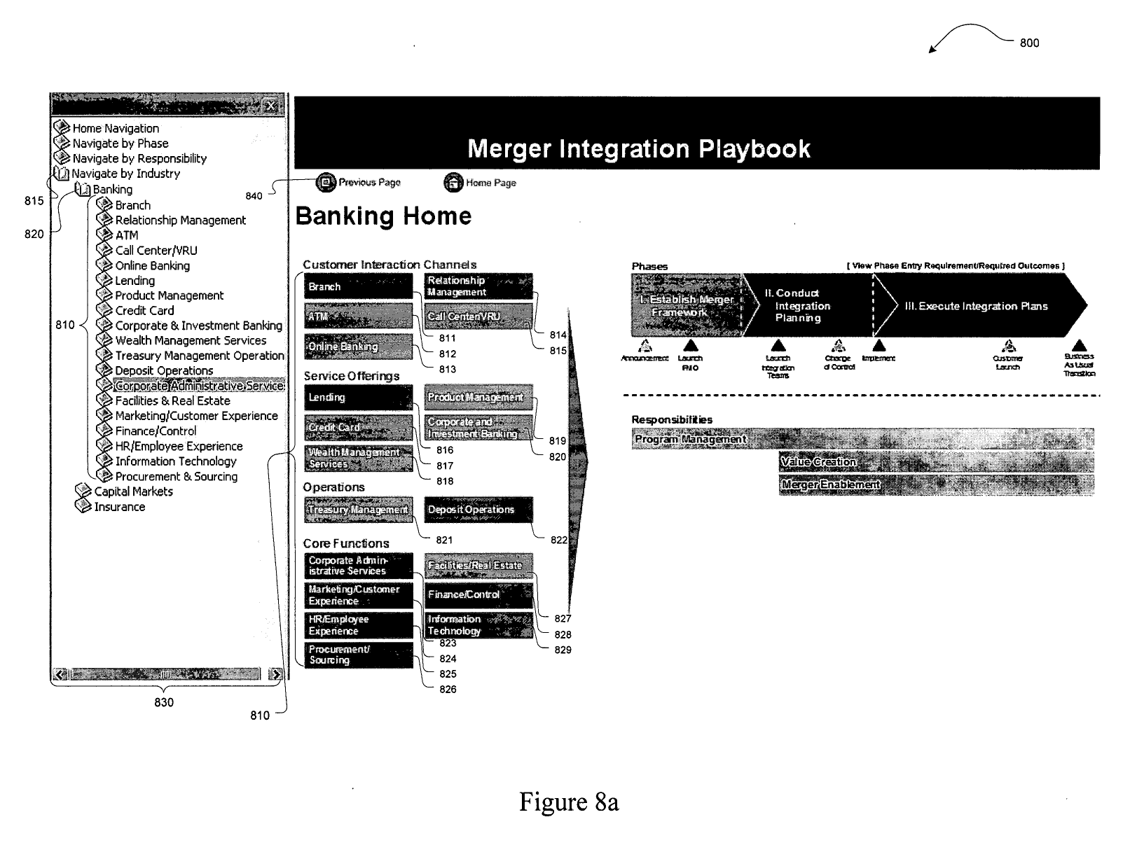

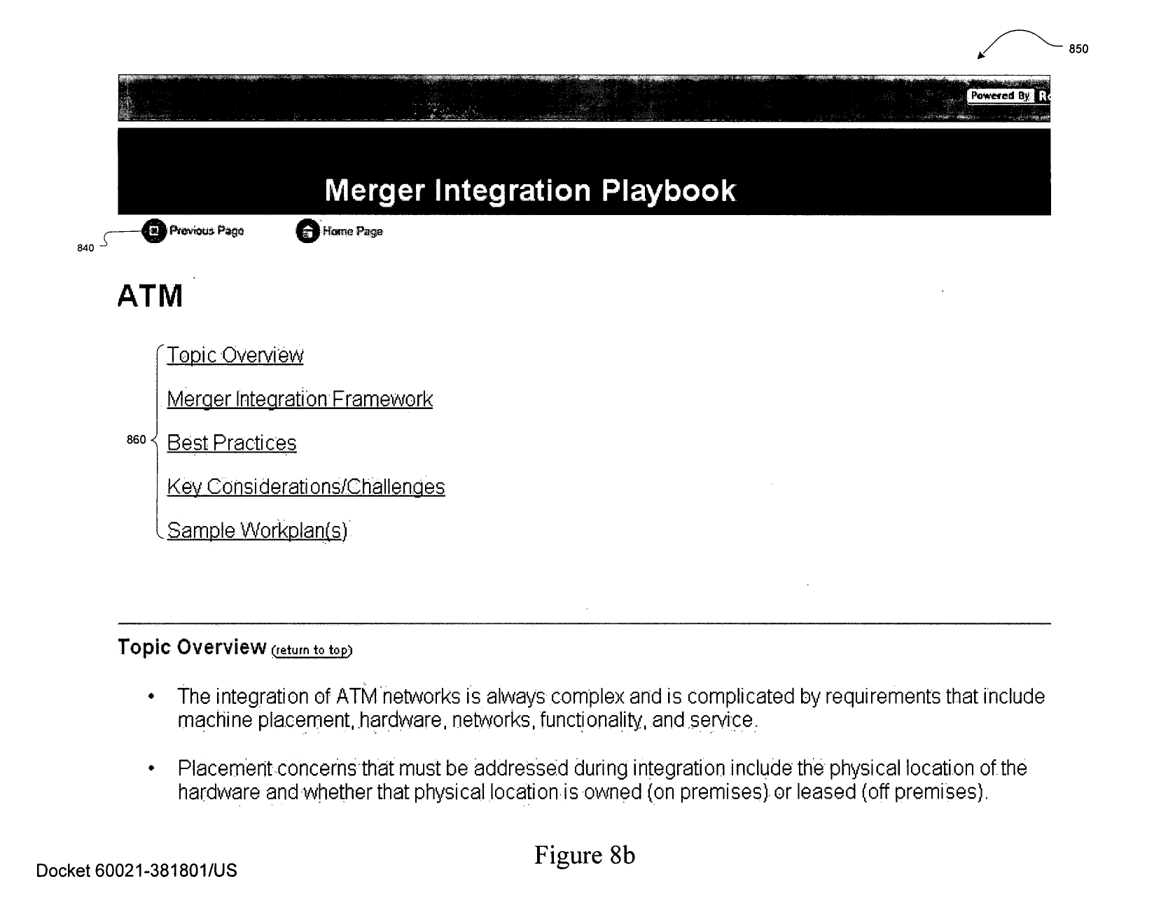

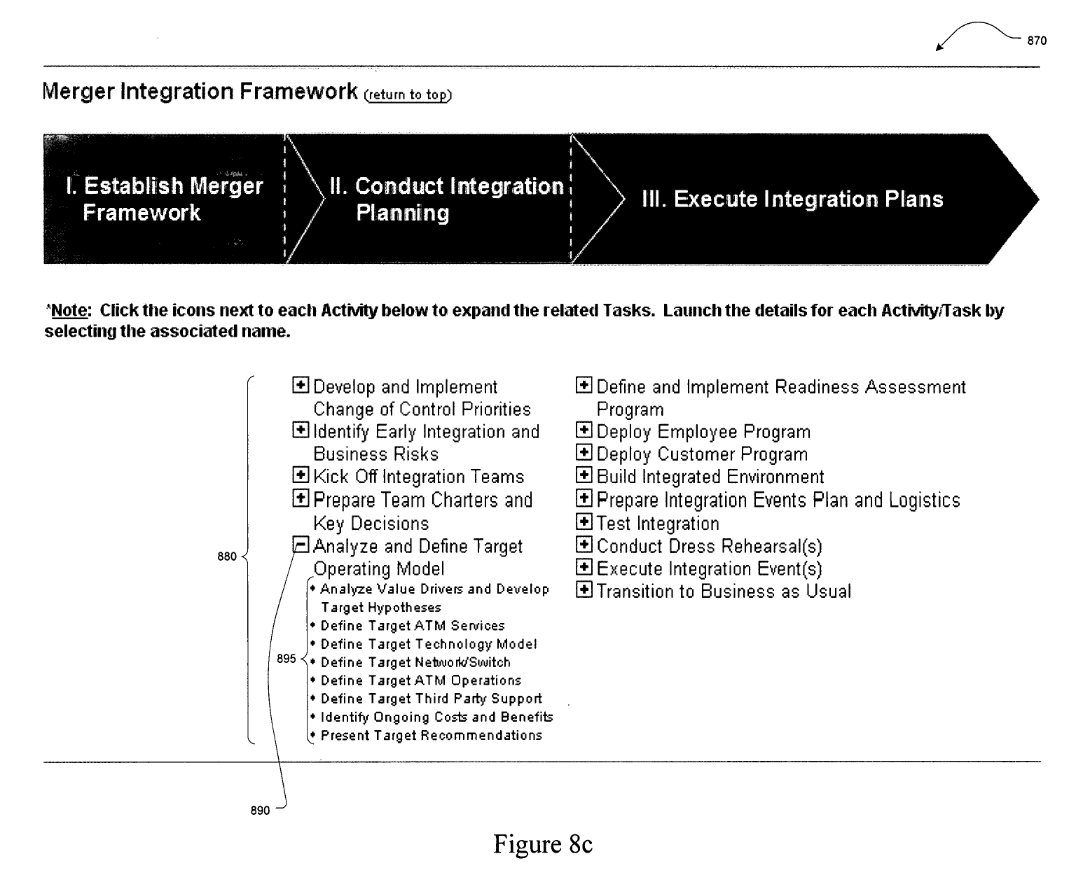

For example, a user may navigate the tool and framework that have been customized for the banking industry, by selecting “Navigate by Industry” 815 and then “Banking” 820, on the table of contents 830, as shown in FIG. 8a. The tool's user interface allows users may navigate by the visual diagram or by the table of contents navigation pane 830. The Merger Integration Playbook provides a flexible method for navigating the methodology by multiple techniques, including navigation by phase, by role/responsibility, and by industry topic, where such topics may optionally be customized or tailored to a specific industry.

The activities and tasks that were previously described as being customized to align with the banking industry including, may be displayed to a user on the Banking Home page 800, as seen in FIG. 8a, including the following the activities and tasks 810: Branches 811, ATM's 112, Online Banking 813, Relationship Management 814, Call Center/VRU 815, Lending 816, Credit Cards 817, Wealth Management Services 818, Product Management 819, Corporate and Investment Banking 820, Treasury Management 821, and Deposit Operations 822. Additionally, as seen in FIG. 8a, the Banking Home page 800 may also display the aforementioned core functions, including: Corporate Administrative Services 823, Marketing/Customer Experience 824, HR/Employee Experience 825, Procurement/Sourcing 826, Facilities/Real Estate 827, Finance/Control 828, and Information Technology 829.

When a user selects an item from the Banking Home page 800, additional information is displayed responsive to the user's selection. For example, when a user selects ATM 812, the tool displays an ATM page 850, seen in FIG. 8b, that displays related topics 860. Further, upon appropriate user selection, the tool may display on an ATM topic screen 870 multiple activities 880 that are associated with ATM's, as seen in FIG. 8c. Specific activities may include tasks that have been tailored to the Banking industry. For example, as seen in FIG. 8c, the activity “Analyze and Define Target Operating Model” 890, includes several customized tasks 895 that are only relevant to ATM's.

In accordance with this approach, the Merger Integration Playbook contains a valuable method of incorporating and integrating the key topics within the banking and retail brokerage industries. These key topics and best practices are substantially overlaid on the standard merger integration framework. Each of the topics described above may be assessed, and the entire framework may be applied to those topics as appropriate. Where gaps in the topics exist or unique approaches are identified, additional activities and tasks may be defined to address the gaps or incorporate the unique approaches.

Additionally, the Merger Integration Playbook tool may be designed, in part, based on activity tracker tools. For example, such activity tracker tools may provide for tracking functionality and a user interface, whereby topics, sub-topics, phases, and attendant information may be entered, viewed, stored, and maintained. When designing and structuring the Merger Integration Playbook, reference may be made to such activity tracker tools in order to incorporate and leverage previously identified best practices, phases, topics, sub-topics, and the like from the activity tracker tools into the Merger Integration Playbook.

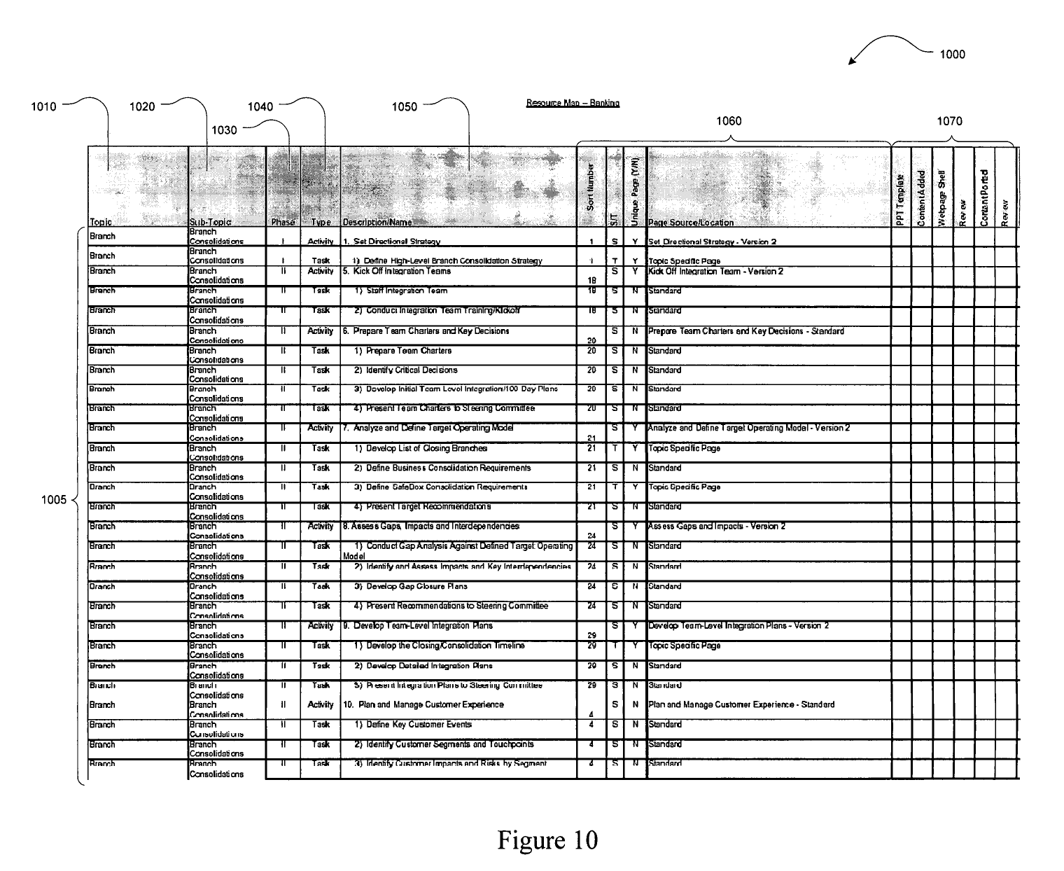

FIG. 10 shows an activity tracker screen 1000 showing a partial resource map within a banking industry merger integration. The partial resource map shows various activities and tasks 1005 for the Branch topic, including information relating to topics 1010, sub-topics 1020, phase 1030, type 1040, description 1050, other attendant information 1060, and a user checklist 1070. The Merger Integration Playbook framework aligns with this activity tracker, which includes activity and task entries 1005 that match the general Merger Integration Playbook framework activities identified in FIGS. 2a-2c, the tasks that correspond to those activities, and activities and tasks that are customized to the banking industry.

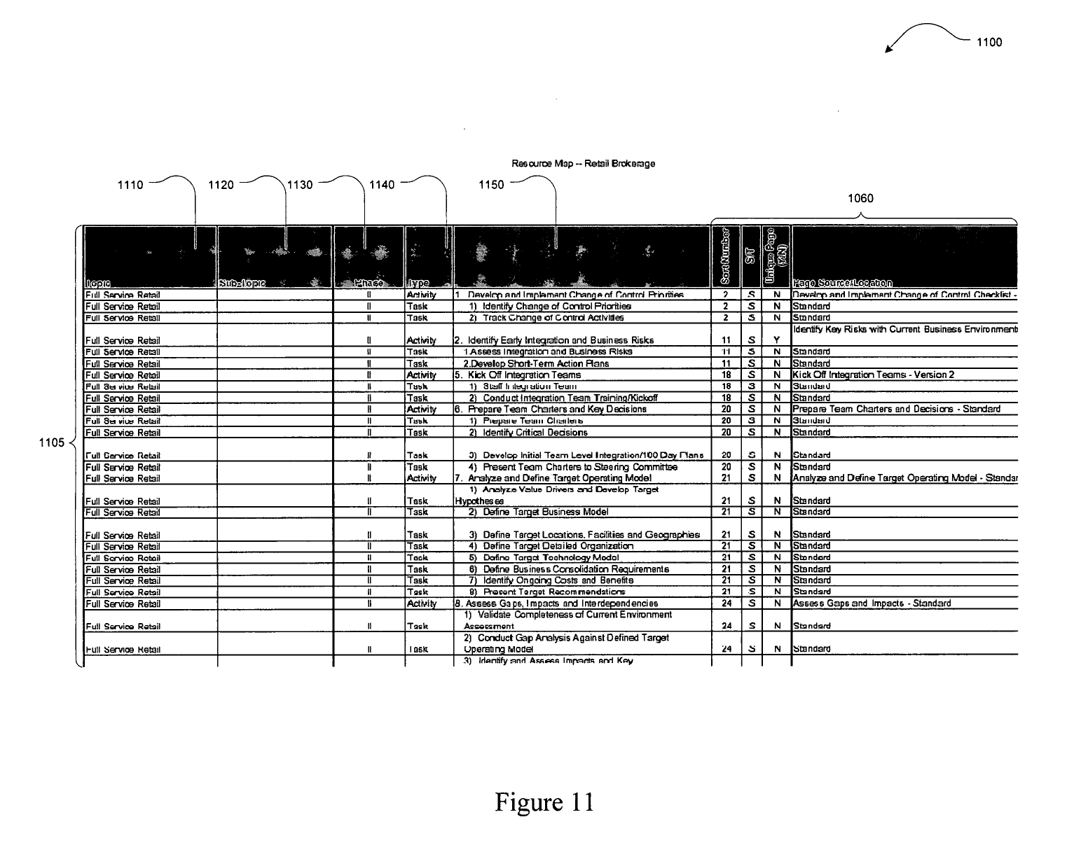

FIG. 11 shows an activity tracker screen 1100 showing a partial resource map within a retail brokerage industry merger integration. The partial resource map shows various activities and tasks 1105 for the Full Service Retail topic, including information relating to topics 1110, sub-topics 1120, phase 1130, type 1140, description 1150, and other attendant information 1160. The Merger Integration Playbook framework aligns with this activity tracker, which includes activity and task entries 1105 that match the general Merger Integration Playbook activities identified in FIGS. 2a-2c, the tasks that correspond to those activities, and activities and tasks that are customized to the retail brokerage industry.

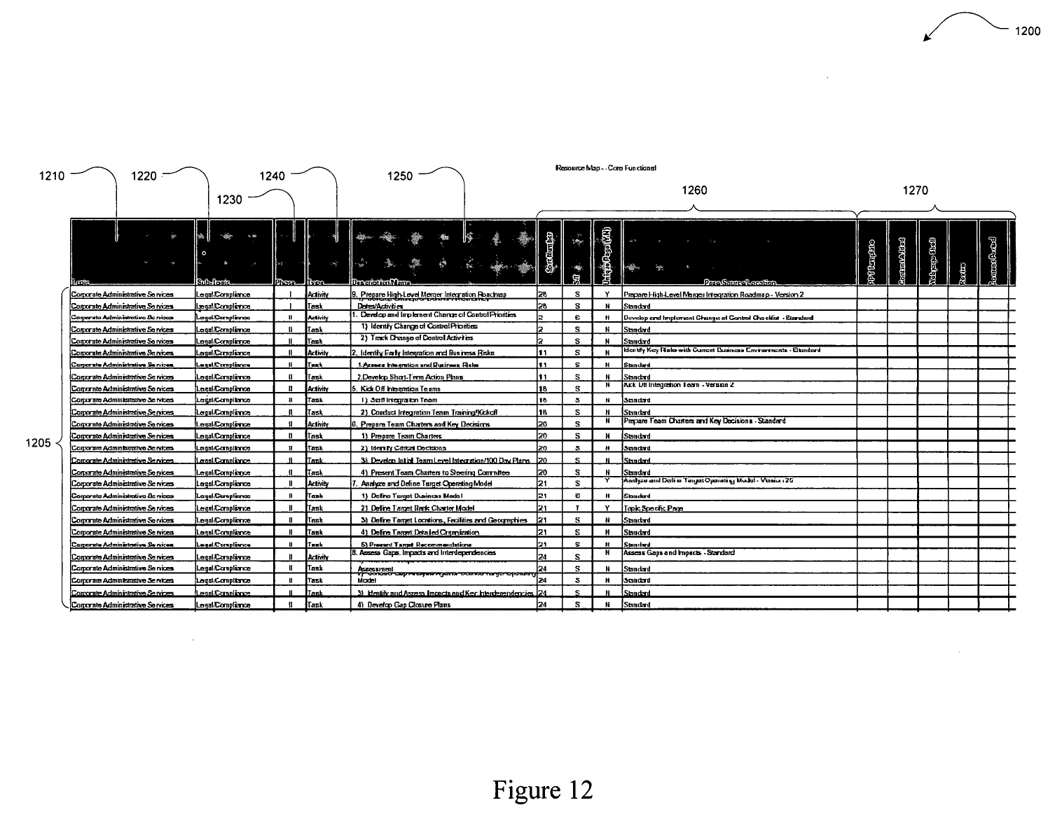

FIG. 12 shows an activity tracker screen 1200 showing a partial resource map for the core functionality topics for a merger integration. The partial resource map shows various activities and tasks 1205 for the Corporate Administrative Services topic, including information relating to topics 1210, sub-topics 1220, phase 1230, type 1240, description 1250, other attendant information 1260, and a user checklist 1270. The Merger Integration Playbook framework aligns with this activity tracker, which includes activity and task entries 1205 that match the general Merger Integration Playbook framework activities identified in FIGS. 2a-2c and the tasks that correspond to those activities.

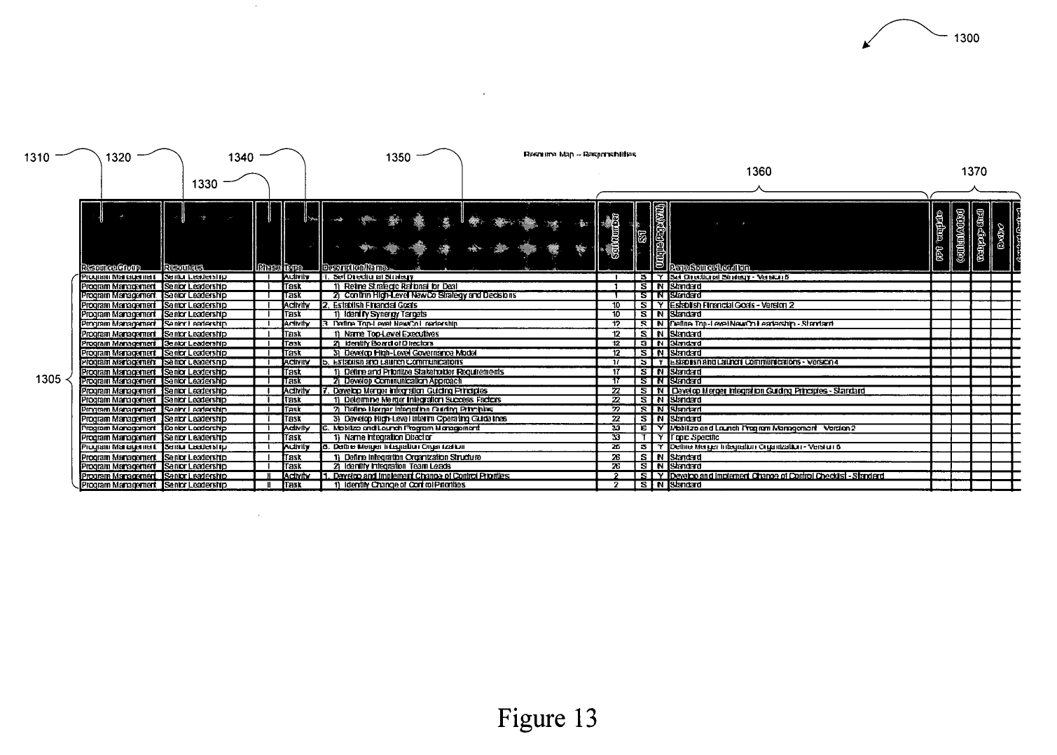

FIG. 13 shows an activity tracker screen 1300 showing a partial resource map for the roles/responsibilities for a merger integration. The partial resource map shows various activities and tasks 1305 for the Program Management role, including information relating to resource group 1310, resources 1320, phase 1330, type 1340, description 1350, other attendant information 1360, and a user checklist 1370. The Merger Integration Playbook framework aligns with this activity tracker, which includes activity and task entries 1305 that match the general Merger Integration Playbook framework activities identified in FIGS. 2a-2c and the tasks that correspond to those activities for the Program Management resource group.

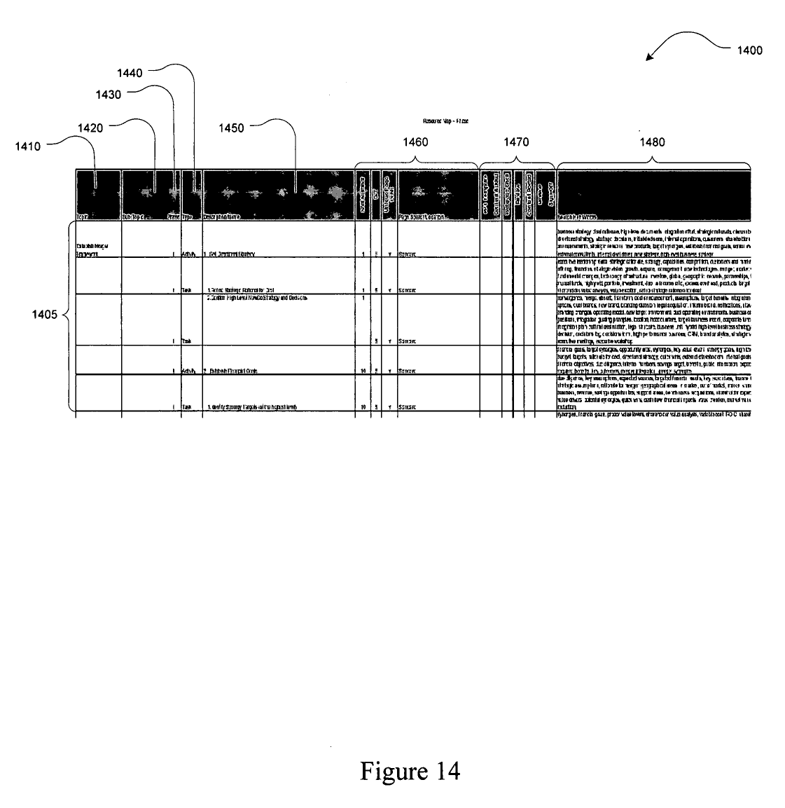

FIG. 14 shows an activity tracker screen 1400 showing a partial resource map for the phases for a merger integration. The partial resource map shows various activities and tasks 1405 for the Establish Merger Framework phase, including information relating to topics 1410, sub-topics 1420, phase 1430, type 1440, description 1450, other attendant information 1460, a user checklist 1470, and search key words 1480. The Merger Integration Playbook framework aligns with this activity tracker, which includes activity and task entries 1405 that match the general Merger Integration Playbook framework activities identified in FIGS. 2a-2c and the tasks that correspond to those activities for the Establish Merger Framework phase.

The Merger Integration Playbook and its corresponding framework may be derived by extrapolating the data maintained in the activity tracker tools. Similarly, the navigation, flow, content, and structure of the framework may be ascertained from the activity tracker or other source of merger tracking process or methodology. Further, different merger integration frameworks may be developed in the same manner as the embodiment described herein through a similar extrapolation exercise.

E. Technical Embodiments of the Merger Integration Playbook Tool

The Merger Integration Playbook tool may provide a user interface that incorporates the foregoing framework methodology via a variety of technological implementations. In one embodiment, the Merger Integration Playbook tool interface may be provided to a user through a website that is accessible to a user by a web browser or other graphical interface using a combination of HTML and JavaScript techniques. JavaScript may be used primarily to navigate through the site, providing drop-down functionality and rollovers. The site may be implemented using IIS and may be compatible with a variety of web browsers.

The website structure may be configured to correspond with the hierarchical structure of the Merger Integration Playbook tool at all levels. This structure allows for more efficient and cost-effective maintenance relative to developing the website with a flat structure. Utilizing the task/activity structure shown in activity tracker screens 1000, 1100, 1200, and 1300, developers can find the location and name of a file that needs to be updated or modified. This structure also allows for the separation and generation of multiple site instances that contain or eliminate the various modules by including or omitting the directory structure.

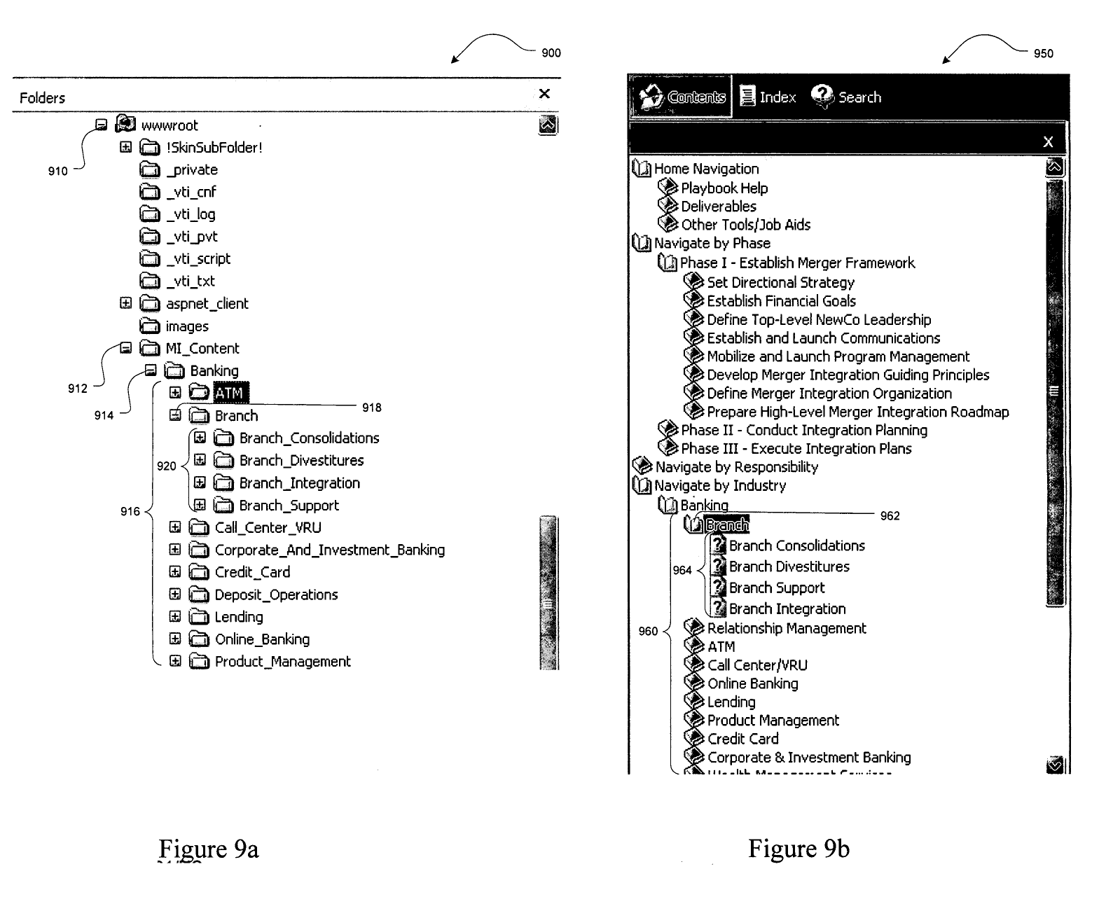

For example, FIG. 9a shows a portion of the directory structure 900 in accordance with one embodiment of the present invention that is customized to align with the banking industry. Under a root directory (wwwroot 910) is a Merger Integration content subdirectory (MI_Content 912) that contains a Banking subdirectory (Banking 914). The Banking subdirectory 914 contains the subdirectories 916 that correspond to the same banking items in the framework 950 that is customized to the banking industry, as seen in FIG. 9b. As seen in FIG. 9b, when a user navigates the framework by industry, the same banking items 960 are displayed to a user that correspond to the banking subdirectories 916 of the directory structure. Further, the directory structure and the framework may also include corresponding tasks. For example, the Branch subdirectory (Branch 918) includes various tasks 920 that correspond to each of the Branch 962 tasks 964 in the framework 950.

The navigation functionality of the tool may be provided by JavaScript or other suitable means. For example, the “Previous Page” button 840, seen in screens 800 and 850 in FIGS. 8a and 8b respectively, uses a JavaScript “Back” function as indicated in the following code segment:

<img border=“0” id=“img2” src=“/images/home_button3F.gif”
alt=“Home Page” fp-
style=“fp-btn: Metal Capsule 2; fp-font: Arial; fp-proportional: 0”
fp-title=“Previous Page”
onClick=“location.href=‘/home.htm’”>

Additionally, JavaScript may be implemented to create drop-down functionality within topic pages. The script toggles the view of the tasks associated with each activity responsive to a user clicking on the + sign to show the tasks and the − sign to hide the tasks, as seen on ATM topic screen 870 in FIG. 8c. This process of changing the visibility of each task area may be provided by the following script:

<script>function toggle(arrow1, arrow2, text1)
{
document.getElementById(arrow1).style.display =
(document.getElementById(arrow1).style.display == ‘none’ ? ‘’ : ‘none’);
document.getElementById(arrow2).style.display =
(document.getElementById(arrow2).style.display == ‘none’ ? ‘’ : ‘none’);
document.getElementById(text1).style.display =
(document.getElementById(text1).style.display == ‘none’ ? ‘’ : ‘none’);
}
</script>

In operation, this script passes an identification of the + sign, the − sign and the text that is to be toggled. The script determines the visibility status associated with the identification and then flips the status accordingly. Each +, − and text area has a unique identification within each topic page. Exemplary HTML code that may be associated with each activity/task area may represented by the following code segment:

<!-- Phase II - Activity 2 -->
<!-- Generate Open and Closed Arrows - Display only Closed Arrow (arrow right) -->

<font face=“Arial” size=“1”>
<p style=“text-indent: −15px; margin-left: 15px; margin-top:0; margin-bottom:0”>
<a href=“JavaScript:;” onclick=“toggle(‘P2A2imageClose’, ‘P2A2imageOpen’,

‘P2A2text’);”>
→ call the toggle function

<span style=“text-decoration: none; display: visible” id=“P2A2imageClose”>
<img src=“/images/aright.gif” border=“0”></span><span style=“text-decoration:

none; display: none” id=“P2A2imageOpen”><img src=“/images/adown.gif”
border=“0”></span></a>

</font>
<span style=“margin-top: 1px; margin-bottom: 1px”>
<font face=“Arial” size=“2”>

<ahref=“/MI_Content/Phase/Phase_II/Identify_Early_Integration_And_Business_Risks/Ident
ify_Early_Integration_And_Business_Risks.htm”>
<span style=“text-decoration: none”>Identify Early Integration and Business
Risks</span></a></font><font face=“Arial” size=“1”>

</font>
</span>
<div id=“P2A2text” style=“display: none;”> → initially hide this text block (until

the +/− sign is toggled)
<p style=“text-indent: −8px; margin-left: 20px; margin-top: 0; margin-bottom: 0”>
<font face=“Wingdings” size=“1”>s</font><font face=“Arial” size=“1”> <a
href=“/MI_Content/Phase/Phase_II/Identify_Early_Integration_And_Business_Risks/Assess
_Integration_And_Business_Risks.htm”><span style=“text-decoration: none”>Assess
Integration and Business Risks</span></a></font></p>
<p style=“text-indent: −8px; margin-left: 20px; margin-top: 0; margin-bottom: 0”>
<font face=“Wingdings” size=“1”>s</font><font face=“Arial” size=“1”> <a
href=“/MI_Content/Phase/Phase_II/Identify_Early_Integration_And_Business_Risks/Develo
p_Short-Term_Action_Plans.htm”>
<span style=“text-decoration: none”>Develop Short-Term Action
Plans</span></a></font></p>
<p style=“text-indent: −8px; margin-left: 20px; margin-top: 0; margin-bottom: 0”> <font
face=“Arial” size=“1”>&nbsp;</font></p>
</div>

Although various representative embodiments of this invention have been described above with a certain degree of particularity, those skilled in the art could make numerous alterations to the disclosed embodiments without departing from the spirit or scope of the inventive subject matter set forth in the specification and claims.

What is claimed is:

1. A method in a computer system for executing an integration of businesses after a merger or acquisition between the businesses, comprising:
establishing a merger framework for providing direction to integrating the businesses,
comprising the step of generating a merger integration roadmap;
developing integration plans in accordance with the merger framework, the integration plans
defining a prioritized set of integration projects, wherein the integration plans are
directed to strategic objectives and tactical objectives, wherein the strategic objectives
are directed toward financial goals and value drives for the financial goals, and
wherein the tactical objectives are directed toward execution activities to achieve the
strategic objectives; and
executing the plurality of integration plans for integrating the businesses, wherein the
computer system directs the integration of businesses in accordance with the merger
framework via a user interface of the computer system, the user interface receiving
input from a user and displaying information to the user corresponding to the merger
framework.

2. The method in a computer system for executing an integration of businesses of claim 1, wherein the step of establishing the merger framework comprises:
setting directional strategy for the integration of businesses, including refining a strategic
rationale for the merger;
launching a management team for the integration of businesses, including defining program
management scope, structure, and team and developing program management
processes; and
defining a merger integration organization for the integration of businesses, including
defining an ingeneration organization structure.

3. The method in a computer system for executing an integration of businesses of claim 1, wherein the step of developing integration plans further comprises analyzing a plurality of value drivers and developing hypotheses.

4. The method in a computer system for executing an integration of businesses of claim 1, wherein the step of developing integration plans further comprises conducting a gap analysis against a predefined target operating model for identifying gaps in integration areas.

5. The method in a computer system for executing an integration of businesses of claim 4, wherein the step of developing integration plans further comprises developing a gap closure plan for resolving the gaps in integration areas.

6. The method in a computer system for executing an integration of businesses of claim 1, wherein the step of executing the integration plans comprises building an integrated environment for use by the integrated businesses, including designing an integrated business environment for the integrated businesses with an integrated business model and designing an integrated technology environment with a conversion program, a conversion process, and a validation approach.

7. The method in a computer system for executing an integration of businesses of claim 1, wherein the step of executing the integration plans comprises executing a dress rehearsal for simulating the integrated businesses, including executing a mock conversion and a product readiness testing, and assessing results thereof and incorporating changes to the integration plans based on said results.

8. A method in a computer system for navigating a methodology tool for an integration of businesses after a merger or acquisition between the businesses, comprising:
providing a methodology tool configured to display to a user a plurality of activities for
accomplishing the integration of businesses, each of the plurality of activities having
associated therewith a plurality of tasks for completing its respective activity;
receiving from the user a first indicia that signifies a desired merger integration role, a
desired merger integration phase, or a desired merger integration industry;
displaying to the user, responsive to receipt of the first indicia, a subset of the plurality of
activities, wherein the subset of the plurality of activities selected from the plurality
of activities based on the first indicia received from the user;
receiving from the user a second indicia, selected from among the displayed subset of the
plurality of activities, that signifies a desired activity; and
displaying to the user, responsive to receipt of the second indicia, a plurality of tasks for
completing the desired activity.

9. The method in a computer system for navigating a methodology tool for an integration of businesses of claim 8, wherein the subset of the plurality of activities are displayed in a graphical timeline format.

10. The method in a computer system for navigating a methodology tool for an integration of businesses of claim 8, wherein the first indicia signifies a desired merger integration role, the desired merger integration role being a program management role, a value creation role, or a merger enablement role.

11. The method in a computer system for navigating a methodology tool for an integration of businesses of claim 10, wherein:
the subset of the plurality of activities is directed to activities to be performed by a person in
the program management role if the first indicia received from the user signifies the
program management role;
the subset of the plurality of activities is directed to activities to be performed by a person in
the value creation role if the first indicia received from the user signifies the value
creation role; and
the subset of the plurality of activities is directed to activities to be performed by a person in
the merger enablement role if the first indicia received from the user signifies the
merger enablement role.

12. The method in a computer system for navigating a methodology tool for an integration of businesses of claim 8, wherein the first indicia signifies a desired merger integration phase, the desired merger integration phase being an establish merger framework phase, a conduct integration planning phase, or a execute integration plans phase.

13. The method in a computer system for navigating a methodology tool for an integration of businesses of claim 12, wherein:
the subset of the plurality of activities is directed to activities to be performed in the establish
merger framework phase of the integration of businesses if the first indicia received
from the user signifies the establish merger framework phase;
the subset of the plurality of activities is directed to activities to be performed in the conduct
integration planning phase of the integration of businesses if the first indicia received
from the user signifies the conduct integration planning phase; and
the subset of the plurality of activities is directed to activities to be performed in the execute
integration plans phase of the integration of businesses if the first indicia received
from the user signifies the execute integration plans phase.

14. The method in a computer system for navigating a methodology tool for an integration of businesses of claim 8, wherein the first indicia signifies a desired merger integration industry, the desired merger integration industry being the banking industry or the retail brokerage industry.

15. The method in a computer system for navigating a methodology tool for an integration of businesses of claim 14, wherein the subset of the plurality of activities is directed to activities to be performed for the integration of businesses in the banking industry if the first indicia received from the user signifies the banking industry.

16. The method in a computer system for navigating a methodology tool for an integration of businesses of claim 14, wherein the subset of the plurality of activities is directed to activities to be performed for the integration of businesses in the retail brokerage industry if the first indicia received from the user signifies the retail brokerage industry.

17. The method in a computer system for navigating a methodology tool for an integration of businesses of claim 8, wherein the first indicia received from the user may further signify a desired merger integration topic.

18. A method in a computer system for navigating a methodology tool for an integration of businesses after a merger or acquisition between the businesses, comprising:
providing a methodology tool configured to display to a user a plurality of activities for
accomplishing the integration of businesses, each of the plurality of activities having
associated therewith a plurality of tasks for completing its respective activity;
receiving from the user a first indicia that signifies a desired merger integration role or a
desired merger integration industry;
displaying to the user, responsive to receipt of the first indicia, a subset of the plurality of
activities, wherein the subset of the plurality of activities selected from the plurality
of activities based on the first indicia received from the user, and wherein the subset
of the plurality of activities may be customized based upon the desired merger
integration role or the desired merger integration industry;
receiving from the user a second indicia, selected from among the displayed subset of the
plurality of activities, that signifies a desired activity; and
displaying to the user, responsive to receipt of the second indicia, a plurality of tasks for
completing the desired activity, wherein the plurality of tasks for completing the
desired activity may be customized based upon the desired merger integration role or
the desired merger integration industry.

19. The method in a computer system for navigating a methodology tool for an integration of businesses of claim 18, wherein the first indicia signifies the banking industry and the subset of the plurality of activities and the plurality of tasks are customized based on predefined best practices for the banking industry.

20. The method in a computer system for navigating a methodology tool for an integration of businesses of claim 18, wherein the first indicia signifies the retail brokerage industry and the subset of the plurality of activities and the plurality of tasks are customized based on predefined best practices for the retail brokerage industry.
